(19) United States
(12) Patent Application Publication
(10) Pub. No.: US 2015/0084849 A1
(43) Pub. Date: Mar. 26, 2015

(54) VEHICLE OPERATION DEVICE

(71) Applicant: HYUNDAI MOTOR COMPANY, Seoul (KR)

(72) Inventor: Dongsoo SHIN, Suwon-si (KR)

(73) Assignee: HYUNDAI MOTOR COMPANY, Seoul (KR)

(21) Appl. No.: 14/144,299

(22) Filed: Dec. 30, 2013

(30) Foreign Application Priority Data
Sep. 23, 2013 (KR) 10-2013-0112836

(51) Int. Cl. G06F 3/01

(52) U.S. Cl. CPC G06F 3/017; G06F 3/016
USPC 345/156

(57) ABSTRACT

A vehicle operation device includes a vibration sensing unit configured to sense vibration or rotation of a vehicle to generate vibration data; a gesture sensing unit configured to sense a user's hand to generate image data; a gesture recognition unit configured to analyze the image data to recognize a gesture and selectively compensate for the recognized gesture depending on the vibration data; and a control unit configured to perform a control operation corresponding to the gesture.

### CROSS-REFERENCE TO RELATED APPLICATION

This application claims priority to and the benefit of Korean Patent Application No. 10-2013-0112836 filed in the Korean Intellectual Property Office on Sep. 23, 2013, the entire contents of which are incorporated herein by reference.

### BACKGROUND

(a) Field of the Invention

The present disclosure relates generally to a vehicle operation device, and particularly, to a vehicle operation device capable of operating a vehicle by recognizing a user's gesture.

(b) Description of the Related Art

Generally, a vehicle information device is a device used to provide driving of a vehicle or convenience and entertainment of a passenger. For example, one type of vehicle information device includes an audio, an audio visual navigation (AVN) system, a telematics, and the like.

Recently, some vehicle information devices are controlled by a remote control method in order to prevent a driver's eyes from deviating from a road in front of a vehicle in order to enable the driver to operate a button of information devices during driving.

As one remote control method, there is a method for controlling a vehicle information device by using a button disposed on a handle of a vehicle or recognizing a user's gesture, and the like. Among those, a method for recognizing a user's gesture is implemented by photographing a user's hand by a camera and using the motion of the user's hand as an intuitive input by analyzing the photographed image.

However, when vibration is generated during the driving of a vehicle, a driver reacts to the vibration unlike the vehicle. In particular, a driver's arm may move in a direction different from a vibration direction of the vehicle. Generally, a vehicle performs a vibration motion which rotates based on breadth, length, and vertical directions of the vehicle, such as yawing, rolling, and pitching depending on road environment.

When a driver's arm is reflexively moved due to impact caused by the vibration, an unintended gesture may be created. When devices within the vehicle are suddenly operated by recognizing a gesture different from the driver's intention during the driving of the vehicle, a driver's attention may be diverted.

The present invention has been made in an effort to provide a vehicle operation device capable of preventing a gesture from being misrecognized due to vibration of a vehicle.

The above information disclosed in this Background section is only for enhancement of understanding of the background of the invention and therefore it may contain information that does not form the prior art that is already known in this country to a person of ordinary skill in the art.

### SUMMARY OF THE INVENTION

An exemplary embodiment of the present invention provides a vehicle operation device, including: a vibration sensing unit configured to sense vibration or rotation of a vehicle to generate vibration data; a gesture sensing unit configured to sense a user's hand to generate image data; a gesture recognition unit configured to analyze the image data to recognize a gesture and selectively compensate for the recognized gesture depending on the vibration data; and a control unit configured to perform a control operation corresponding to the gesture.

The vibration sensing unit may include a sensor unit configured to sense the vibration or rotation of the vehicle; and a filter unit configured to stabilize an output of the sensor unit and remove noise. The gesture sensing unit may include a camera configured to photograph the user's hand.

The gesture recognition unit may detect the hand from the image data and analyze a moving pattern of the hand input during a gesture input activation period to recognize the gesture. The gesture recognition unit may analyze the vibration data to determine a generation timing and strength of the vibration or rotation and compensate for the gesture depending on the determined generation timing and strength of the vibration or rotation.

The gesture recognition unit may invalidate the compensation of the gesture and initialize the input of the gesture during a predetermined period including the generation timing of the vibration or rotation when the vibration or rotation is generated at the strength of a predetermined threshold value or more at a specific timing.

The gesture recognition unit may invalidate the gesture recognized from a starting of timing of the gesture input activation period and initialize the input of the gesture when the vibration or rotation is generated at the strength of the predetermined threshold value or more at the specific timing.

The gesture recognition unit may compensate for the pattern of the recognized gesture in a time unit depending on a moving displacement of the vibration or rotation when the vibration or rotation is generated at the strength less than the predetermined threshold value at the specific timing. The gesture recognition unit may compensate for the pattern of the recognized gesture in a time unit depending on the moving displacement of the vibration or rotation when the vibration or rotation is generated at a continuous timing.

According to the exemplary embodiments of the present invention, it is possible to prevent the gesture from being misrecognized independent of the user's intention by compensating for the recognized gesture by sensing the vibration or the rotation of the vehicle.

Further, according to the exemplary embodiments of the present invention, when the instant vibration or rotation is generated in the vehicle, it is possible to invalidate the gesture recognition to receive the gesture again and when the continuous vibration or rotation is generated in the vehicle, it is possible to compensate for the pattern of the recognized gesture to prevent the misrecognition due to the distortion of the gesture.

### BRIEF DESCRIPTION OF THE DRAWINGS

FIG. 1 is a block diagram illustrating a vehicle operation device according to an exemplary embodiment of the present invention.

FIGS. 2A and 2B are diagrams for describing a vehicle operation method according to an exemplary embodiment of the present invention.

FIGS. 3A, 3B and 3C are diagrams for describing a vehicle operation method according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising”, will be understood to imply the inclusion of stated elements but not the exclusion of any other elements.

Hereinafter, exemplary embodiments which may be readily practiced by those skilled in the art to which the present invention pertains will be described in detail with reference to the accompanying drawings.

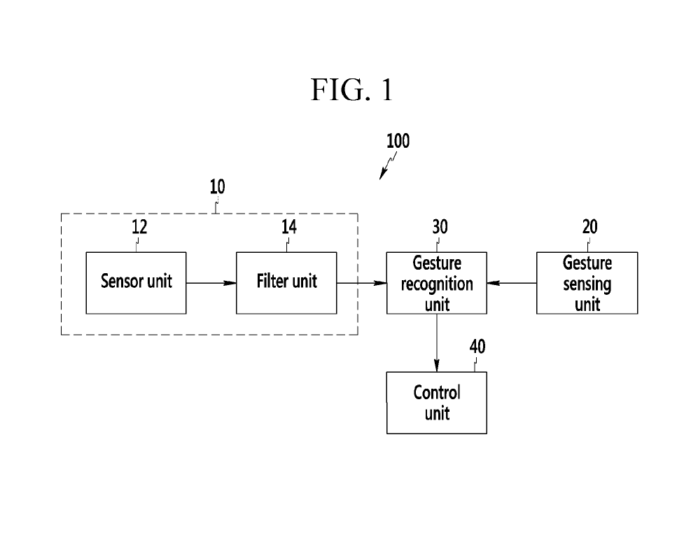

FIG. 1 is a block diagram illustrating a vehicle operation device according to an exemplary embodiment of the present invention.

Referring to FIG. 1, a vehicle operation device 100 according to the exemplary embodiment of the present invention includes a vibration sensing unit 10, a gesture sensing unit 20, a gesture recognition unit 30, and a control unit 40. In this configuration, the vibration sensing unit 10 senses a state of a vehicle to generate vibration data. The vibration sensing unit 10 may include a sensor unit 12 which senses a vibration or a rotation motion of the vehicle and a filter unit 14 which stabilizes an output of the sensor unit 12 and removes noise to output vibration data.

In this configuration, the sensor unit 12 may include a plurality of sensors, which may sense vibrations outside the vehicle, such as an acceleration sensor, a gyro sensor, a vibration sensor, a tilt sensor, a damper sensor, and a tire pressure sensor.

The gesture sensing unit 20 senses a user's hand and photographs a sensed motion of the user's hand to generate image data. The gesture sensing unit 20 may include at least one of a 3D camera or an infrared camera which photographs the user's hand or a motion sensor which senses the motion of the user's hand, and the like. Here, the camera or the motion sensor may be installed in the vicinity of the user, for example, at a portion in front of a driver's seat.

The gesture sensing unit 20 may include a lighting device (not illustrated) which irradiates light in a user's direction. The gesture sensing unit 20 may photograph the user's hand by using the lighting device when lighting in the vehicle is low.

The gesture recognition unit 30 receives the vibration data from the vibration sensing unit 10 and receives the image data from the gesture sensing unit 20. The gesture recognition unit 30 analyzes the image data to recognize the user's gesture.

In detail, the gesture recognition unit 30 detects the user's hand from the image data and recognizes the gesture by analyzing a moving pattern of the hand input during a gesture input activation period. Here, the gesture input activation period may be a period in which the moving pattern of the hand is input as predetermined gesture input starting pattern and ending pattern.

Further, the gesture recognition unit 30 analyzes the vibration data to determine the timing and strength at which the vibration or rotation of the vehicle is generated and selectively compensates for the recognized gesture depending on the timing and strength at which the determined vibration or rotation is generated.

Here, the gesture recognition unit 30 invalidates the recognized gesture when the vibration or rotation of the vehicle is instantly generated and is of the strength of a predetermined threshold value or more. Further, the gesture recognition unit 30 compensates for the pattern of the recognized gesture in a time unit when the vibration or rotation of the vehicle is instantly generated and is the strength less than a predetermined threshold value.

Further, the gesture recognition unit 30 compensates for the pattern of the recognized gesture in the time unit when the vibration or rotation of the vehicle is continuously generated. That is, the gesture recognition unit 30 initializes the gesture recognition when the instant vibration or rotation is generated with high strength to make distortion of the gesture large. Further, the gesture recognition unit 30 compensates for the recognized gesture when the instant vibration or rotation is generated at weak strength or the vibration or rotation is a periodic vibration or rotation.

In detail, the gesture recognition unit 30 may determine the vibration or rotation as the instant vibration or rotation when the timing of the vibration or rotation generated is less than a predetermined frequency and may determine the vibration or rotation as the periodic vibration or rotation when the timing of the vibration or rotation generated is a predetermined frequency or more.

When the instant vibration or rotation is generated at the predetermined strength or more, the gesture recognition unit 30 invalidates the compensation of the recognized gesture and initializes an input operation of the gesture during a predetermined period including the timing when the vibration or rotation is generated, in the gesture recognition period. Here, the gesture recognition unit 30 may set a predetermined time before and after the timing when the vibration or rotation of the vehicle is generated, as the predetermined period.

The exemplary embodiment of the present invention is not limited thereto, and the gesture recognition unit 30 may invalidate all the recognized gestures when the instant vibration or rotation is generated at a predetermined strength or more. That is, all the gestures input after the timing when the user's gesture starts to be input may be invalidated.

Further, the gesture recognition unit 30 compensates for the gesture input during the gesture input activation period in the time unit, depending on a moving displacement of the vibration or rotation when the instant vibration or rotation is generated less than the predetermined strength. To this end, the gesture recognition unit 30 may use the vibration data to calculate the moving displacement of the vibration or rotation and compensate for the moving pattern of the hand depending on the calculated result.

Further, the gesture recognition unit 30 compensates for the gesture input during the gesture input activation period in the time unit, depending on the moving displacement of the vibration or rotation even when the periodic vibration or rotation is generated.

The control unit 40 extracts an execution function corresponding to the gesture to perform a control operation of an information device. For example, the control unit 40 may perform a control operation of turning up the volume of an audio source, reducing the temperature of an air conditioner, and the like.

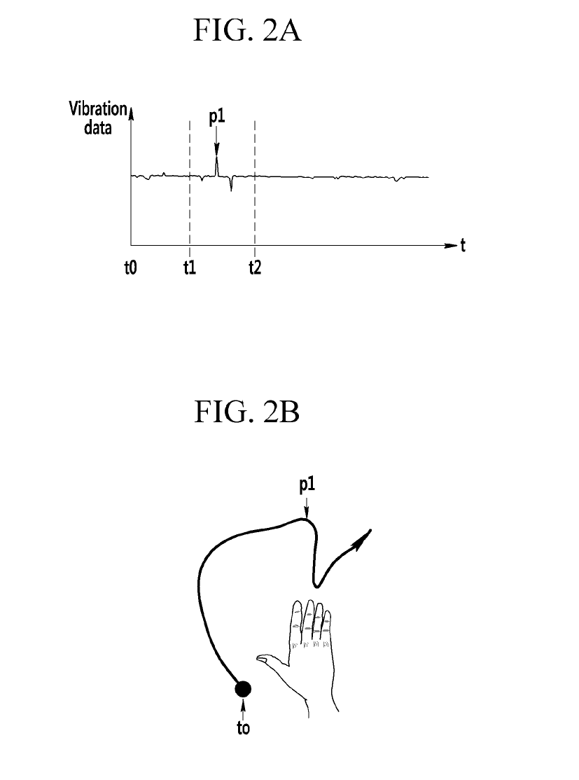

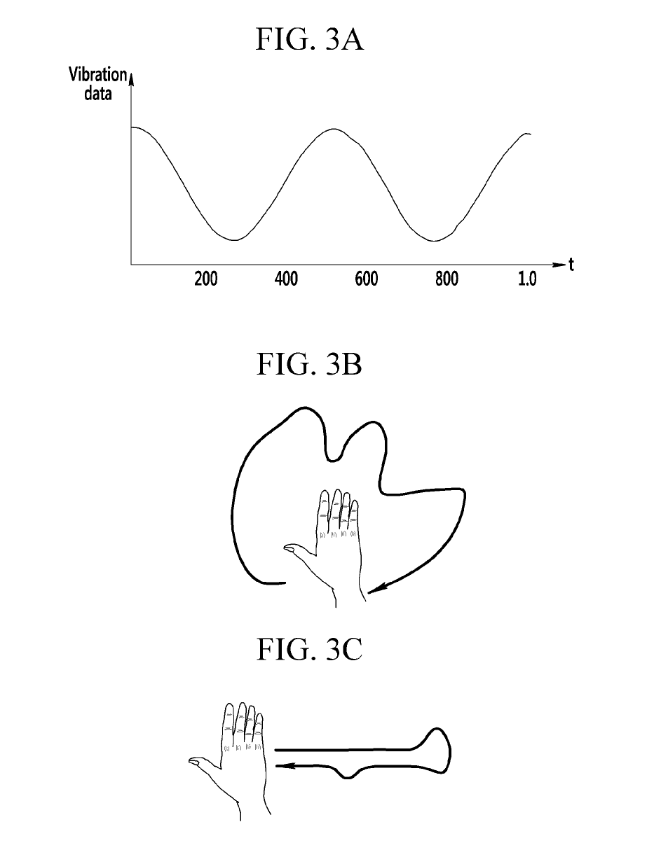

FIGS. 2 and 3 are diagrams for describing a vehicle operation method according to an exemplary embodiment of the present invention.

Referring to FIGS. 2A to 2B, the vibration sensing unit 10 senses the vibration or rotation motion of the vehicle to generate the vibration data. For example, when the vibration of the vehicle is instantly generated at p1 timing, as illustrated in FIG. 2A, the vibration data are generated. Here, the case in which the vibration of the vehicle is generated at the strength of the threshold value or more will be described by way of example.

In this case, the user starts the gesture input from t0 timing such that the gesture input is in an activated state, and as illustrated in FIG. 2B, it can be observed that the motion of the hand is distorted due to the vibration while the user inputs the gesture in a direction shown by an arrow.

Next, the gesture recognition unit 30 invalidates the gesture input within t1 and t2 timings before and after the vibration is generated based on the p1 timing or invalidates the gesture input after the t0 timing. Further, the gesture recognition unit 30 initializes the gesture input operation. Therefore, the input gesture or the distortion of the gesture is not recognized, such that the control operation of the device which does not meet the user's intention is not generated.

Meanwhile, referring to FIGS. 3A to 3C, when the vibration of the vehicle is continuously generated, as illustrated in FIG. 3A, the vibration data which are periodically vibrated are generated. In this case, as illustrated in FIGS. 3B and 3C, it can be observed that the vibration is generated while the user inputs the gesture in the direction shown by an arrow such that the motion of the hand is distorted.

Next, the gesture recognition unit 30 compensates for the moving pattern of the hand in the time unit depending on the moving displacement of the vibration and recognizes the gesture depending on the compensated moving pattern of the hand. Therefore, misrecognition due to the distortion of the gesture is prevented.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A vehicle operation device, comprising:
a vibration sensing unit configured to sense vibration or rotation of a vehicle to generate vibration data;
a gesture sensing unit configured to sense a user's hand to generate image data;
a gesture recognition unit configured to analyze the image data to recognize a gesture and selectively compensate for the recognized gesture depending on the vibration data; and
a control unit configured to perform a control operation corresponding to the gesture.

2. The vehicle operation device of claim 1, wherein:
the vibration sensing unit includes:
a sensor unit configured to sense the vibration or rotation of the vehicle; and
a filter unit configured to stabilize an output of the sensor unit and remove noise.

3. The vehicle operation device of claim 1, wherein:
the gesture sensing unit
includes a camera configured to photograph the user's hand.

4. The vehicle operation device of claim 1, wherein:
the gesture recognition unit
detects the hand from the image data and analyzes a moving pattern of the hand input during a gesture input activation period, in which a pattern of the detected hand is recognized as a predetermined pattern, to recognize the gesture.

5. The vehicle operation device of claim 4, wherein:
the gesture recognition unit
analyzes the vibration data to determine a generation timing and strength of the vibration or rotation and compensates for the gesture depending on the determined generation timing and strength of the vibration or rotation.

6. The vehicle operation device of claim 5, wherein:
the gesture recognition unit
invalidates the compensation of the gesture and initializes the input of the gesture during a predetermined period including the generation timing of the vibration or rotation when the vibration or rotation is generated at a strength of a predetermined threshold value or more at a specific timing.

7. The vehicle operation device of claim 5, wherein:
the gesture recognition unit
invalidates the gesture recognized from a starting timing of the gesture input activation period and initializes the input of the gesture when the vibration or rotation is generated at the strength of the predetermined threshold value or more at the specific timing.

8. The vehicle operation device of claim 5, wherein:
the gesture recognition unit
compensates for the pattern of the recognized gesture in a time unit depending on a moving displacement of the vibration or rotation when the vibration or rotation is generated at the strength less than the predetermined threshold value at the specific timing.

9. The vehicle operation device of claim 5, wherein:
the gesture recognition unit
compensates for the pattern of the recognized gesture in a time unit depending on the moving displacement of the vibration or rotation when the vibration or rotation is generated at a continuous timing.
